(19) United States
(12) Patent Application Publication
(10) Pub. No.: US 2026/0287124 A1
(43) Pub. Date: Sep. 24, 2026

(54) IMPROVED DEVICE FOR ATTACHING A TANK INTENDED TO CONTAIN A PRESSURIZED GAS

(71) Applicant: PLASTIC OMNIUM NEW ENERGIES FRANCE, Lyon (FR)

(72) Inventors: Chloé MARCHAL, Bruxelles (BE); Sébastien DOLLE, Bruxelles (BE); Héloïse ROLLAND, Bruxelles (BE); Yann BOULANT, Bruxelles (BE)

(73) Assignee: PLASTIC OMNIUM NEW ENERGIES FRANCE, Lyon (FR)

(21) Appl. No.: 19/475,217

(22) PCT Filed: Apr. 26, 2024
(86) PCT No.: PCT/EP2024/061539

§ 371 Date: Oct. 14, 2025

(30) Foreign Application Priority Data
Apr. 28, 2023 (FR) FR2304296

(51) Int. Cl. F17C 13/08; F17C 13/00

(52) U.S. Cl. CPC F17C 13/084; F17C 13/002; F17C 2201/0109; F17C 2201/035; F17C 2205/0192; F17C 2270/0168

(57) ABSTRACT

A device for attaching a tank containing a pressurized gas for a motor vehicle includes: a support member having a single cut and folded sheet metal element and including a receiving region which is delimited by the edges of a cut-out made in a central region of the sheet metal and configured to receive an end neck of the pressurized-gas tank, and a body which is provided with two opposite reinforcing walls which are obtained by folding the sheet metal and extend substantially in a plane transverse to the axis along which the tank extends. The device also includes a retaining collar attached to the support member, the receiving region and the retaining collar delimiting between them a passage opening configured to receive the end neck of the tank.

The invention relates to tanks for containing a pressurized gas, in particular on-board tanks in motor vehicles. The invention relates more specifically to a device for attaching a tank for containing a pressurized gas. The gas in question includes, for example, but is not limited to, natural gas, biogas, liquefied petroleum gas, hydrogen.

The various functions of the above-mentioned tank are to:
contain the pressurized gas, that is to say mechanically withstand the forces exerted by the pressure of the gas,
ensure sealing from the outside,
fill with pressurized gas, using an on-tank valve mounted at a longitudinal end of the tank,
deliver pressurized gas using the same on-tank valve,
attach to the supporting structure,
withstand conditions of transport and use,
withstand harmful environmental effects, external mechanical and thermal stresses,
withstand tank manufacturing conditions.

These tanks can be mounted on all types of fixed or mobile equipment (road, rail, sea, air or space vehicles). Pressurized gas tanks are made of metal or, more recently, composite materials, for reasons of weight savings and safety.

When the tank is mounted on a motor vehicle, it is attached to a component of the latter, such as a crossmember, usually via an end neck of the tank, which enables an on-tank valve or other device to be fitted to the tank to deliver the gas contained inside. To this end, an attachment device of the tank is provided to connect the end neck to the crossmember.

The attachment devices of background art often consist of a solid metal block, which gives them good resistance in the event of a vehicle crash, particularly in the direction of the tank's longitudinal axis. Conversely, such an attachment device has the disadvantage of being heavy and making it difficult to take up play between the attachment device and the end neck of the tank.

Document WO2021151684 describes a hydrogen tank held on a motor vehicle frame by an attachment device in particular comprising a semi-circular tongue and a corner element receiving the neck of the tank. The corner element is screw-fastened to a block element welded to the frame. The disadvantage of such an attachment device is that the corner element is difficult to produce with the precision required for satisfactory coupling between the latter and the tank, particularly as the receiving region for the neck of the tank is defined solely by folding a piece of sheet metal.

Also known from US2019092827 is an attachment element for attaching the neck of a pressure tank, in particular for a vehicle. The attachment device comprises a bracket, which is attached to the neck of the tank at an opening, and a retaining element arranged between the neck and the opening. The disadvantage of such an attachment device is that it offers little resistance in the event of a vehicle crash, particularly in the direction of the tank's longitudinal axis. Positioning the neck of the tank in this attachment device is also difficult.

Also known from document DE102018122439 is a high-pressure tank, in particular for hydrogen, for a motor vehicle. The tank is attached to the vehicle body by at least one connecting plate extended by spacers, which is screwed to crossmembers. Another disadvantage of such an attachment device is that it offers little resistance in the event of a vehicle crash, particularly in the direction of the tank's longitudinal axis, and also makes it difficult to position the neck of the tank in the attachment device.

Also known from documents CN107120529, US2020248874, US2004075034, U.S. Pat. No. 8,915,682 and KR20180117968 are devices for securing a tank intended to contain a pressurized gas for a motor vehicle, which comprise a receiving region and a retaining collar, the receiving region and the retaining collar delimiting therebetween a passage opening configured to receive the end neck of the tank.

One of the aims of the invention is to overcome these drawbacks by offering a device for attaching a tank that is lightweight and crash-resistant, simple to manufacture and allows easy positioning of the tank end neck.

For this purpose, the invention relates to a device for attaching a tank intended to contain a pressurized gas for a motor vehicle,

characterized in that it comprises:
a support member consisting of a single cut and folded sheet metal element, comprising a receiving region delimited by the edges of a cut-out made in a central region of the sheet metal and configured to receive an end neck of the pressurized-gas tank, as well as a body which is provided with two opposite reinforcing walls which are obtained by folding the sheet metal and extend substantially in a plane normal to the longitudinal axis along which the tank extends, and
a retaining collar attached to the support member, the receiving region and the retaining collar delimiting between them a passage opening configured to receive the end neck of the tank.

By virtue of the fact that the support member consists of a single cut and folded sheet metal element and a retaining collar the attachment device according to the invention is particularly lightweight. Good resistance to impacts and stresses in the longitudinal direction of the tank is also ensured by the fact that the body is provided with two opposing reinforcing walls obtained by folding the sheet metal and extending substantially in a plane normal to the longitudinal axis along which the tank extends. The fact that the receiving region of the end neck of the pressurized gas tank is delimited by the edges of a cut-out made in a central region of the sheet metal means that the receiving region can be precisely defined. This makes it easier to position the and neck in the attachment device, while keeping the manufacturing method simple. Positioning of the end neck is also made easier by the flexibility provided by the retaining collar, which can be used to compensate for any play, offering the possibility of inserting a spacer element between the neck of the tank and the retaining collar.

In order to improve the compactness of the attachment device and its resistance to stress, the reinforcing walls are interconnected by a receiving wall of the retaining collar intended to receive attachment means for attaching the retaining collar to the body.

Preferably, the passage opening comprises a spacer element such as an annular receiving element, in particular made from polymeric material, configured to receive the end neck of the tank.

The annular receiving element is chosen to block a longitudinal end of the tank, for example, the longitudinal end of the tank carrying the on-tank valve (OTV), in particular by preventing rotation of the end neck of the tank about the longitudinal axis of the tank.

Alternatively, the annular receiving element is chosen to release one longitudinal end of the tank, for example, the longitudinal end opposite the longitudinal end of the tank carrying the on-tank valve, allowing the end neck of the tank to slide into the annular receiving element to allow unhindered expansion of the tank along its longitudinal axis during filling.

According to a particular embodiment of the invention which allows improved positioning of the annular receiving element, the annular receiving element comprises a protrusion and the retaining collar comprises a groove configured to receive the protrusion.

To make the attachment device even lighter, the retaining collar consists of a single cut and folded sheet metal element.

According to a particular embodiment of the invention which simplifies the manufacture of the attachment device, and in particular the folding of the sheet metal, the reinforcing walls are substantially parallel to one another.

According to a particular embodiment of the invention which further simplifies the manufacture of the attachment device, and in particular the folding of the sheet metal, the support member has a U-shaped cross-section.

To improve the resistance stress of the attachment device, the body further comprises a first pair of reinforcing tabs obtained by folding the sheet metal and connecting the free ends of the reinforcing walls, so as to partially enclose a volume delimited by the two reinforcing walls.

To further improve the resistance to stress of the attachment device, the body further comprises a second pair of reinforcing tabs obtained by folding the sheet metal and connecting respective opposite faces of the reinforcing walls, so as to partially enclose a volume delimited by the two reinforcing walls, the reinforcing tabs of the second pair of tabs being opposite those of the first pair of tabs in pairs.

According to a particular embodiment of the invention, which simplifies the manufacture of the attachment device, and in particular the folding of the sheet metal, the reinforcing tabs are substantially parallel to one another.

According to a particular embodiment of the invention which further simplifies the manufacture of the attachment device, and in particular the folding of the sheet metal, the reinforcing tabs extend substantially perpendicular to the reinforcing walls.

To further improve the resistance to stress of the attachment device, the body further comprises at least one reinforcing tongue obtained by folding the sheet metal, connecting two opposite segments of the edges of the cut-out made in the sheet metal, so as to partially close off a volume delimited by the two reinforcing walls and the receiving region.

To simplify the attachment of the attachment device to the motor vehicle, the body further comprises attachment bases provided with at least one attachment hole designed to receive means for attaching the attachment device to an attachment crossmember of the motor vehicle.

In order to simplify the attachment of the attachment device to the motor vehicle and the manufacture of the attachment device, and in particular the folding of the sheet metal, the attachment bases are obtained by folding an extension of the reinforcing tabs of the first pair of tabs, this folding preferably being carried out at 90°.

According to a particular embodiment of the invention which simplifies the structure of the attachment device and enables a different integration within the motor vehicle, the support walls are configured to receive an attachment crossmember of the motor vehicle between them.

To simplify the attachment of the attachment device to the motor vehicle, at least one of the two reinforcing walls is provided with at least one attachment hole designed to receive means for attaching the attachment device to an attachment crossmember of the motor vehicle.

The invention also relates to a tank for containing a pressurized gas for a motor vehicle, characterized in that it comprises an attachment device according to the invention.

### BRIEF DESCRIPTION OF THE FIGURES

The invention will be better understood upon reading the following description, which is provided merely as example and with reference to the appended drawings, wherein:

FIG. 1 is a perspective view of a tank intended to contain a pressurized gas and fitted with a device for attachment to a motor vehicle attached to a motor vehicle crossmember according to a first embodiment of the invention;

FIG. 2 is a perspective view of the attachment device shown in FIG. 1;

FIG. 3 is a perspective view of a support member of the attachment device shown in FIG. 1;

FIG. 4 is a bottom view of the support member shown in FIG. 3;

FIG. 5 is a side view metal from which the support member shown in FIG. 3 was made;

FIG. 6 is a perspective view of the retaining collar of the attachment device shown in FIG. 1;

FIG. 7 is a perspective view of an annular receiving element of the attachment device shown in FIG. 1;

FIG. 8 is a perspective view device for attachment to a motor vehicle attached to a motor vehicle crossmember according to a second embodiment of the invention;

FIG. 9 is a perspective view of a support member of the attachment device shown in FIG. 8,

FIG. 10 is a bottom view of the support member shown in FIG. 9;

FIG. 11 is a side view of the sheet metal from which the support member shown in FIG. 8 was made.

FIG. 12 is a perspective view device for attachment to a motor vehicle according to a third embodiment of the invention, without an annular receiving element;

FIG. 13 is a perspective view of the device for attachment to a motor vehicle shown in FIG. 12, with annular receiving element.

### DETAILED DESCRIPTION

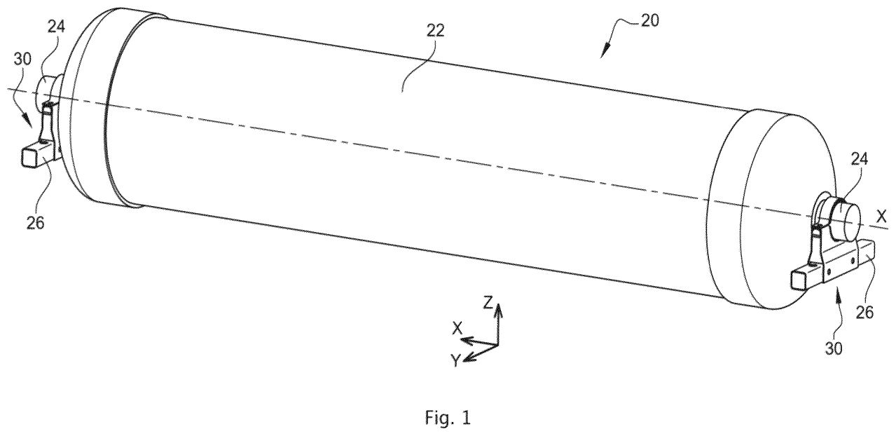

FIG. 1 shows a tank 20 for containing a pressurized gas according to an attachment device 30 according to a first embodiment of the invention. Here, the tank 20 has a generally cylindrical or tubular central portion, or cylinder 22, which extends along a longitudinal axis X of an orthonormal reference frame XYZ shown in FIG. 1 to 4 and 8 to 10.

At each of the longitudinal ends of this cylinder 22, the tank 20 comprises an end neck 24. The end necks 24 are cylindrical or tubular in shape and project from the cylinder 22, that is to say their cross-section (in a sectional plane parallel to the YZ plane) is circular. They can be connected to functional elements for distributing gas out of the tank 20 through the end neck 24, such as an on-tank valve.

The tank 20 is designed to be installed in a motor vehicle, of which only two crossmembers 26 are shown in FIGS. 1, 2 and 8. The attachment crossmember 26 connect and secure the tank 20 to the rest of the vehicle.

The attachment crossmembers 26 are elongated elements, in this case hollow beams of rectangular cross-section, extending in a direction substantially parallel to an axis Y perpendicular to the longitudinal axis X of the tank.

In variants not shown, the attachment crossmembers 26 have a different cross-sectional shape, e.g. circular, and are therefore generally cylindrical or tubular.

The tank 20 is attached at each of its longitudinal ends to an attachment crossmember 26 via its end necks 24.

To this end, each end neck 24 is received by an attachment device 30 connecting and securing the tank 20 to the attachment crossmember 26.

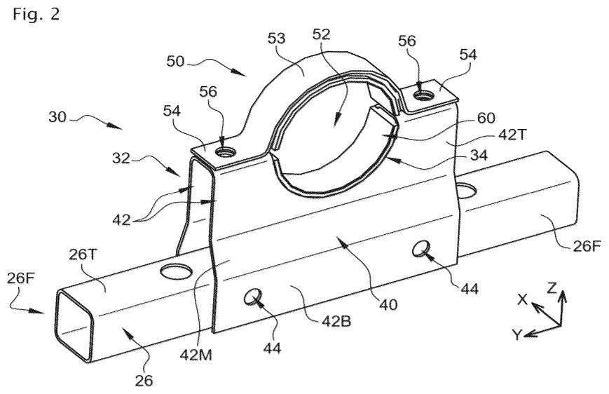

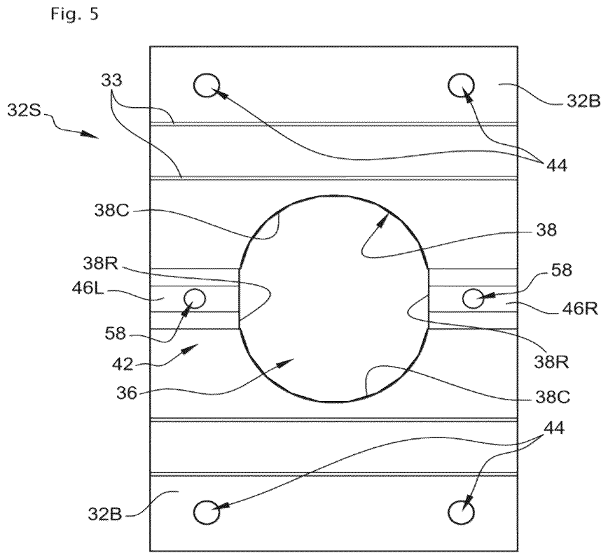

The attachment device 30, shown in more detail in FIG. 2, comprises a support member 32 made from a single piece of cut and folded sheet metal element 32S, to lighten the structure. The sheet metal element 32S is shown before folding in FIG. 5. In particular, the folding lines 33 are shown.

The support member 32 of the attachment device 30 comprises a receiving region 34 delimited by the edges 38 of cut-out 36 made in a central region of the sheet metal 32S.

In the examples shown in the figures, the cut-out 36 is substantially oval in shape, more particularly in the shape of a Cassini oval. More specifically, the cut-out 36 comprises a continuous edge 38 divided into parallel straight edges 38R, connected at each of their free ends by semicircular edges 38C.

In this first embodiment, the sheet metal 32S is symmetrical with respect to a horizontal axis passing through the horizontal axis of symmetry of the cut-out 36, passing through the middles of the straight edges 38R. It is also symmetrical with respect to a vertical median axis passing through the vertical symmetrical axis of the cut-out 36.

The receiving region 34 is configured to receive an end neck 24 of the pressurized gas tank. Preferably, the edges 38 of the cut-out forming the receiving region 34 are complementary in shape to that of the end neck 24 of the tank they receive.

In this first embodiment of the invention, the receiving region 34 is more particularly formed by the semicircular edges 38C which receive the end neck 24. Their semi-circular shape has been chosen to complement the circular shape of the end neck 24.

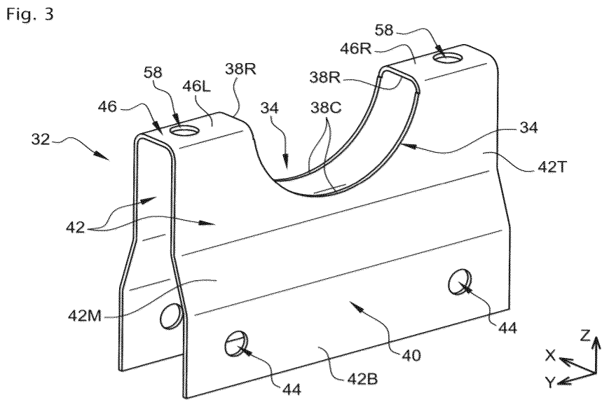

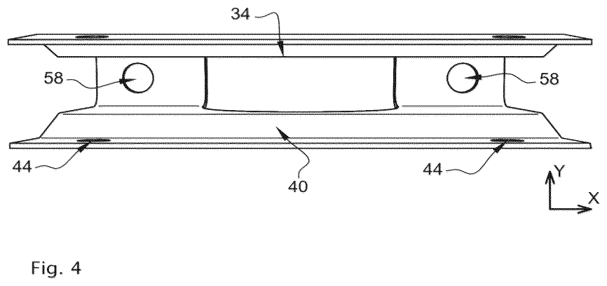

As can be seen in greater detail in FIGS. 3 and 4, the support member 32 further comprises a body 40 fitted with two opposing reinforcing walls 42 obtained by folding the sheet metal 32S.

The reinforcing walls 42 extend substantially in a plane normal to the longitudinal axis X along which the tank extends, that is to say a plane parallel to the YZ plane in the figures.

In the examples shown in the figures, in order to simplify the manufacture of the attachment device 30, and in particular the folding of the sheet metal 32S, the reinforcing walls 42 are substantially parallel to one another. More specifically, the reinforcing walls 42 are symmetrical with respect to a median plane parallel to the YZ plane.

In the example shown in FIGS. 2 to 4, each reinforcing wall 42 comprises a top section 42T, wherein the substantially flat cut-out 36 is made.

This top section 42T is extended, opposite the cut-out 36, by a substantially flat middle section 42M, oblique with respect to the top section 42T, so as to extend away from the attachment crossmember 26.

Indeed, in this first embodiment, the support walls 42 are configured to receive the attachment crossmember 26 between them. However, as the spacing between the top sections 42T is less than the width of the attachment crossmember 26, the middle sections 42M must diverge away from the attachment crossmembers 26.

In other words, the middle sections 42M allow the port member 32 to overlap the attachment crossmember 26 to which the attachment device 30 is attached. The middle sections 42M of each reinforcing wall 42 thus each extend in opposite direction to the other, that is to say they diverge from one another.

Each middle section 42M is extended, opposite the cut-out 36, by a substantially flat bottom section 42B, comprising the free end of the support wall 42.

The bottom sections 42B are more particularly parallel to the front walls 26F of the attachment crossmember 26, that is to say the front walls 26F of the attachment crossmember 26 extend in a plane parallel to the YZ plane.

Here, the bottom sections 42B extend on both sides of the attachment crossmember 26. Their spacing is therefore greater than the width of the attachment crossmember 26.

In addition, the bottom sections 42B are pressed against the front walls 26F of the attachment crossmember 26. The bottom sections 42B are therefore flat and parallel to one another due to the rectangular cross-section of the attachment crossmember 26. The bottom sections 42B are also parallel to the top sections 42T.

To attach the attachment device 30 to the attachment crossmember 26, at least one of the two reinforcing walls 42 is provided with at least one attachment hole 44 designed to receive attachment means (not shown in FIGS. 1 to 7) for attaching the attachment device 30 to the attachment crossmember 26.

In the example shown in FIGS. 1 to 7, attachment holes 44 are provided in the bottom sections 42B.

To this end, the bottom sections 42B are each provided with a pair of attachment holes 44 for the passage of attachment means (not shown in FIG. 2) such as screws or rivets. Naturally, the number of attachment holes 44 in each bottom section 42B can vary.

The means of attaching the attachment device 30 to the attachment crossmember 26 are designed here to cooperate with the front walls 26F of the attachment crossmember 26.

The reinforcing walls 42 are connected to one another by a receiving wall 46, in this case divided into two wall sections: a left-hand receiving wall 46L and a right-hand receiving wall 46R, arranged on both sides of the receiving region 34, which here more particularly connect the top sections 42T of the reinforcing walls.

The receiving wall 46 is substantially flat and extends substantially perpendicular to the top sections 42T, and more particularly in a plane parallel to the XY plane.

In this way, the body 40 of the support member has a generally U-shaped cross-section in a sectional plane parallel to the XZ plane.

The attachment device 30 also comprises a retaining collar 50 attached to the support member 32. More particularly, in the examples shown in the figures, it is the receiving wall 46 which receives the means for attaching the retaining collar 50 to the body 40 of the support member.

As can be seen in FIG. 2, the receiving region 34 and the retaining collar 50 delimit between them a passage opening 52 configured to receive the end neck 24 of the tank. As the end neck 24 is circular in cross-section, the passage opening 52 is circular in cross-section.

The passage opening 52 extends radially in a plane substantially parallel to the plane YZ normal to the longitudinal axis X of the tank 20. It is delimited in this plane by the retaining collar 50 on the one hand, and the receiving region 34 of the support member 32 on the other hand. In the direction of the longitudinal axis X, it is delimited by the reinforcing walls 42 of the body of the support member.

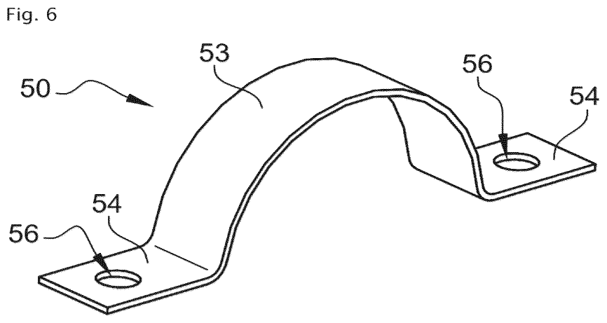

The retaining collar 50 is shown individually in FIG. 6. Preferably, to make the attachment device 30 even lighter, it consists of a single cut and folded sheet metal element, which in the example shown is a substantially rectangular sheet whose longitudinal dimension is much greater than its lateral dimension.

In particular, the retaining collar 50 comprises a central arch 53, which is complementary in shape to the end neck 24 of the tank, and is therefore here a semi-circular arch. The diameter of this central arch 53 is chosen so as to be substantially the same as that of the semicircular edges 38C of the cut-out 36, in order to form the circular passage opening 52 enabling the end neck 24 to be properly enclosed.

The retaining collar 50 further comprises two attachment pads 54 on both sides of the central arch 53. The attachment pads 54 are delimited from the central arch 53 by shoulders which form the folding lines of the sheet metal from which the retaining collar 50 is made.

The attachment pads 54 are attached to the receiving wall 46 of the body 40. Here, they are substantially flat, as is the receiving wall 46, to maximize their contact surface.

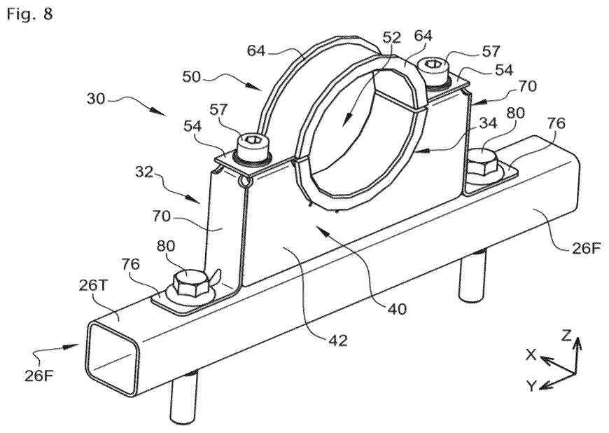

A retaining hole 56 is provided in each of the attachment pads 54 to allow the passage of retaining means 57 from the retaining collar 50 to the receiving wall 46. These attachment means 57, not shown in FIG. 2 but shown in FIG. 8, are screws. In an alternative not shown, rivets could be used.

As can be seen in FIGS. 3 and 4 in particular, the receiving wall 46 comprises corresponding receiving holes 58 (shown in FIG. 3 but not in FIG. 5) to allow the attachment means 57 to pass through. Naturally, the number of retaining holes 56 and receiving holes 58 can vary, but the number of retaining holes 56 preferably responds to the number of receiving holes 58, and vice versa.

Preferably, an annular receiving element 60, in particular made of polymer material, configured to receive the end neck 24 of the tank, is arranged in the passage opening 52.

The annular receiving element 60 is chosen to block a longitudinal end of the tank 20, for example, the longitudinal end of the tank 20 carrying an on-tank valve, in particular by preventing rotation of the end neck 24 of the tank about the longitudinal axis X of the tank 20.

Alternatively, the annular receiving element 60 is chosen to release one longitudinal end of the tank 20, for example, the longitudinal end opposite the longitudinal end of the tank 20 carrying the on-tank valve, allowing the end neck 24 of the tank to slide into the annular receiving element 60 to allow unhindered expansion of the tank 20 along its longitudinal axis X during filling.

In particular, the annular receiving element 60 comprises a band 62 whose width corresponds to that of the retaining collar 50. Optionally, depending on the function of the annular receiving element 60, the band 62 is extended at each of its free edges by a flange 64 forming an annular shoulder of the band 62. In this case, each flange 64 covers the semicircular edges 38C of the cut-out 36 and the free edges of the central arch 53 of the retaining collar 50.

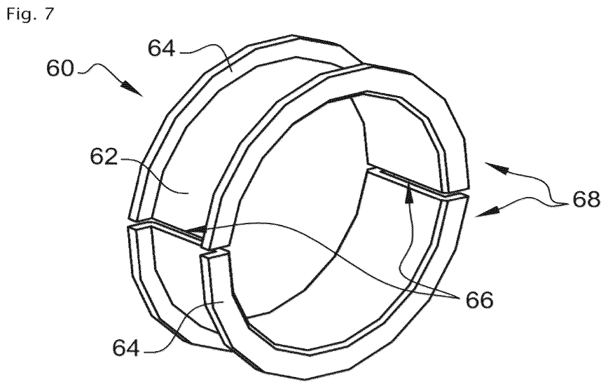

Preferably, to facilitate its insertion into the passage opening 52, the annular receiving element 60 comprises one or more slots 66, which may in particular divide it into two semicircular parts 68, as can be seen in FIG. 7 in particular.

With reference to FIGS. 8 to 11, a second embodiment of the attachment device 30 according to the invention will now be described. Only those elements that differ from the first embodiment will be described below.

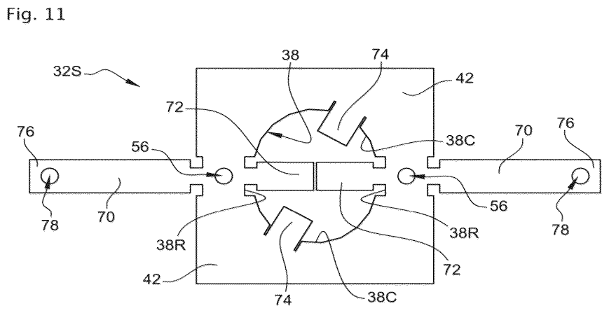

The support member 32 is still obtained from a single cut and folded sheet metal element 32S. The sheet metal element 32S is shown before folding in FIG. 11.

By contrast, in this second embodiment, the reinforcing walls 42 do not comprise three top, middle and bottom sections, but only one substantially flat section. Indeed, in this second embodiment, there is no need for divergent sections such as the middle section sections 42M, as the support member 32 does not straddle the attachment crossmember 26. This is due to the fact that in this second embodiment, the support member 32 is not attached to the front walls 26F of the attachment crossmember, but to its top wall 26T which connects these two front walls 26F, that is to say the wall parallel to the XY plane, as will be seen below.

The reinforcing walls 42 are nevertheless connected by left 46L and right 46R receiving walls, as in the first embodiment.

In addition, as in the first embodiment, a cut-out 36 is made in a central region of the sheet metal 32S and has a similar Cassini oval shape comprising parallel rectilinear edges 38R, connected at each of their free ends by semicircular edges 38C.

Furthermore, in order to improve the resistance to stress of the attachment device 30, in this second embodiment, the body 40 further comprises a first pair of reinforcing tabs 70 obtained by folding the sheet metal and connecting the respective free ends of the reinforcing walls 42, so as to partially enclose a volume delimited by the two reinforcing walls 42. More specifically, the reinforcing tabs 70 connect the free ends of the reinforcing walls 42 extending in the direction Y.

The reinforcing tabs 70 are delimited here by a substantially rectangular edge.

As can be seen in particular in FIG. 11, each reinforcing tab 70 of the first pair is connected here to the left 46L and right 46R receiving wall by a left 71L and right 71R connecting wall, respectively, which is narrower than the width of the reinforcing tabs 70.

In a variant not shown, the reinforcing tabs 70 of the first pair are welded to the free ends of reinforcing walls 42.

To simplify the manufacture of the attachment device 30, and in particular the folding of the sheet metal 32S, the reinforcing tabs 70 are substantially parallel to one another.

In this particular embodiment, the reinforcing tabs 70 extend substantially perpendicular to the reinforcing walls 42. Thus, in this specific case, the reinforcing tabs 70 each extend in a plane parallel to the XZ plane.

As a result, the volume delimited by the first pair of reinforcing tabs 70, the reinforcing walls 42 and the receiving re wall 46 is substantially parallelepipedic.

To further improve the resistance to stress of the attachment device, in this second embodiment, the body 40 further comprises a second pair of reinforcing tabs 72 obtained by folding the sheet metal 32S and connecting the respective opposite faces of the reinforcing walls 42, so as to partially enclose a volume delimited by the two reinforcing walls 42.

The second pair of reinforcing tabs 72 are opposite of the first pair of tabs 70 in pairs, and are in particular arranged on both sides of the receiving region 34. They are preferably parallel to the first reinforcing tabs 70. Thus, in this specific case, the reinforcing tabs 72 of the second pair of tabs each extend in a plane parallel to the XZ plane.

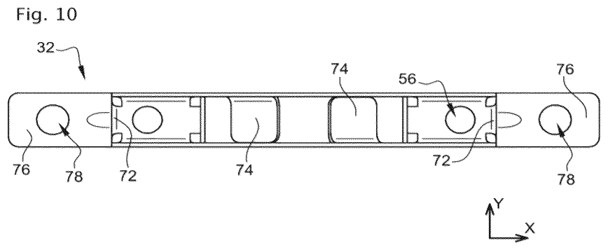

Preferably, the second pair of reinforcing tabs 72 is located inside the volume delimited by the first reinforcing tabs 70, the receiving wall 46 and the reinforcing walls 42, as can be seen in FIG. 10. This increases the resistance of the attachment device 30 to stress exerted in the direction of the longitudinal axis X.

To further improve the resistance to stress of the attachment device 30, in this second embodiment, the body 40 further comprises at least one reinforcing tongue 74 obtained by folding the sheet metal 32S connecting two opposite segments of the edge 38 of the cut-out 36 made in the sheet metal 32S, so as to partially close off a volume delimited by the two reinforcing walls 42 and the receiving region 34.

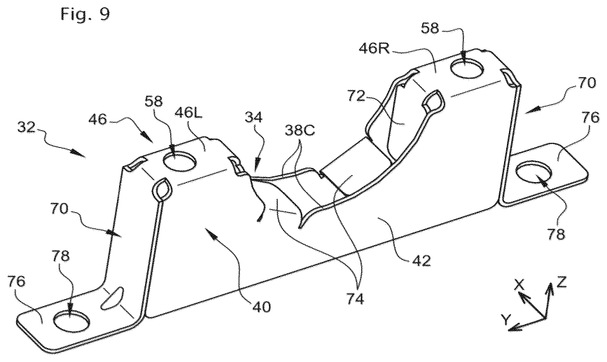

In the example shown in FIGS. 8 to 11, the body 40 comprises two reinforcing tongues 74. More particularly, the reinforcing tongues connect the two semicircular edges 38C, so as to fill the gap between the two reinforcing walls 42 at the receiving region 34, as shown in FIG. 9.

As can be seen in FIG. 11, before folding the metal sheet 32S, the reinforcing tongues 74 extend obliquely with respect to the first reinforcing tabs 70, forming an angle of about 45° with the edges 38R of the cut-out 36. Preferably, the reinforcing tongues 74 project from the edges 38C in axial symmetry with respect to the receiving region 34, so as to better fill the gap between the two reinforcing walls 42 at the receiving region 34. It should be noted that variants not shown, a single reinforcing tongue 74 is provided, or more than two reinforcing tongues 74, for example three or four reinforcing tongues 74.

In this second embodiment, and as shown in particular in FIG. 8, the body 40 further comprises attachment bases 76 provided with at least one attachment hole 78 designed to receive means 80 for attaching the attachment device 30 to the attachment crossmember 26. The attachment means 80 of the attachment device 30 for attaching to the attachment crossmember 26 here are screws, it could be rivets for example.

The attachment bases 76 are obtained by folding an extension of the reinforcing tabs of the first pair of tabs 70, this folding preferably being at 90°.

In this second embodiment, the receiving region 34 of the end neck 24 of the tank is formed by the semicircular edges 38C of the cut-out, as well as by the tongues of the reinforcement 74. In an alternative of this second embodiment not shown, the support member 32 has no reinforcing tongues 74, and the receiving region is formed by the semicircular edges 38 of the cut-out.

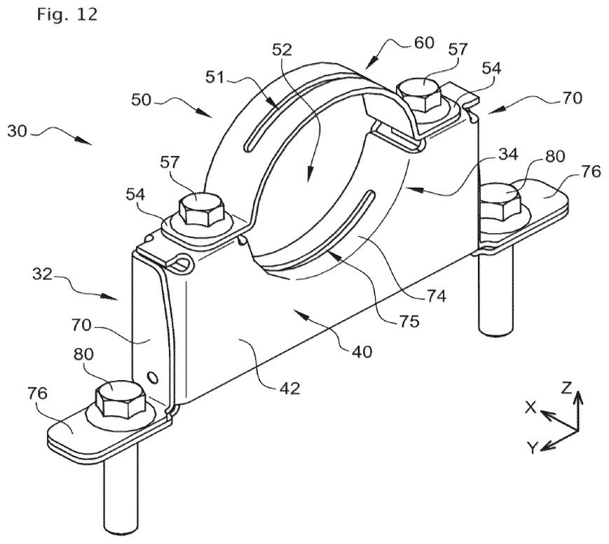

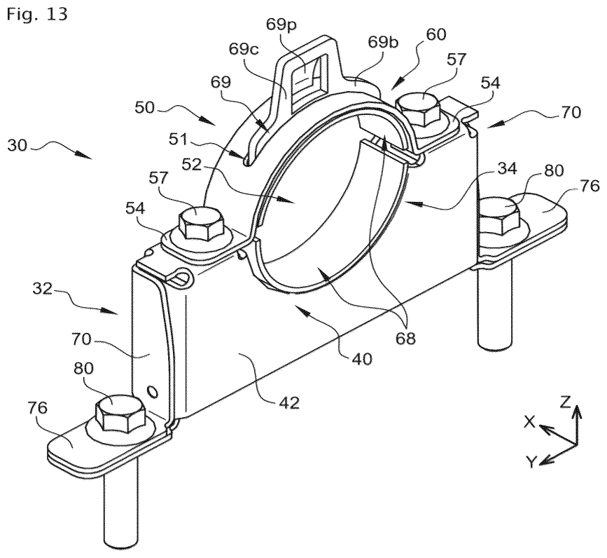

With reference to FIGS. 12 and 13, a third embodiment of the attachment device 30 according to the invention will now be described. Its components are similar to those of the second embodiment except for the retaining collar 50, the annular receiving element 60 and the reinforcing tongue 74.

As can be seen in FIG. 12, the retaining collar 50 is in fact provided, in its semi-circular central part, with a groove 51, for example a through groove. The groove 51 here forms a circular arc and is substantially parallel to the edge of the retaining collar 50.

In addition, in this third embodiment, the body 40 comprises only one reinforcing tongue 74, complementary in shape to the retaining collar 50, which together form a ring that grips the end neck 24 of the tank 20. A groove 75, for example a through groove, is formed in the reinforcing tongue 74. The groove 75 here forms a circular a substantially parallel to the edge of the reinforcing tongue 74, and also to the edge of the retaining collar 50. Preferably, the groove 75 of the reinforcing tongue 74 and the groove 51 of the retaining collar 50 are of similar size and shape.

As can be seen in FIG. 13, the grooves 51 of the retaining collar 50 and 75 of the reinforcing tongue 74 are each configured to receive a protrusion 69 of the annular receiving element 60. Here, the protrusion 69 is integral with the annular receiving element 60. In this example, as the annular receiving element 60 is composed of two semicircular parts 68, each semicircular part 68 carries a protrusion 69, and is preferably integral with each semicircular part 68. In an alternative not shown, the annular receiving element 60 is in one piece and comprises two protrusions 69 arranged diametrically opposite one another around the annular receiving element 60.

Each protrusion 69 extends in a direction perpendicular to that of the longitudinal axis X of the tank, which in the examples shown in the figures corresponds to the axis Z. In the example shown in FIG. 13, each protrusion 69 comprises a base 69b extending from one end to the other of the groove 51, 75 wherein it is inserted, and a central portion 69c which forms an extension of the base 69b extending in the direction of extension of the protrusion 69, here the axis Z.

Each protrusion 69 is provided with a resilient snap-in tab 69p formed by a cut-out in the protrusion 69. The resilient snap-in tab 69p snaps into the groove 51, 75 wherein the protrusion 69 is inserted. In the example shown in FIG. 13, the resilient snap-in tab 69p is carried by the central part 69c of the protrusion 69.

The Invention is not limited to the embodiments presented, and other embodiments will become clearly apparent to a person skilled in the art. In particular, it may be possible to attach the attachment device 30 according to the first embodiment to the top wall 26T of the attachment crossmember, or to attach the attachment device 30 according to the second embodiment to the front walls 26F of the attachment crossmember.

### LIST OF REFERENCES

20: Tank
22: Cylinder of the tank
24: End neck(s) of the tank
26: Attachment crossmember(s) of the tank
26F: Front wall of the crossmember
26T: Top wall of the crossmember
30: Attachment device of the tank
32: Support member of the attachment device
32S: Sheet metal of the support member
33: Folding lines of the sheet metal
34: Receiving region
36: Cut-out of the sheet metal
38: Edges of the cut-out
38C: Semicircular edges of the cut-out
38R: Straight edges of the cut-out
40: Body of the support member
42: Reinforcing walls of the body of the support member
42B: Bottom section of the reinforcing wall
42M: Middle section of the reinforcing wall
42T: Top section of the reinforcing wall
44: Attachment hole of the body
46: Receiving walls
46L: Left receiving wall
46R: Right receiving wall
50: Retaining collar
51: Groove
52: Passage opening
53 Central arch
54: Attachment pads
56: Retaining holes
57: Attachment means of the collar
58: Receiving holes
60: Annular receiving element
62: Band of the annular element
64: Flanges of the annular element
66: slots of the annular element
68: Semicircular parts of the annular element
69: Protrusion of the annular receiving element
69b: Base of the protrusion
69c: Central part of the protrusion
69p: Resilient snap-in tab
70: First pair of reinforcing tabs
71L: Left connecting wall
71R: Right connecting wall
72: Second pair of reinforcing tabs
74: Reinforcing tongues
75: Groove
76: Attachment bases
78: Attachment holes
80: Attachment means to the crossmember

1. A device for attaching a tank intended to contain a pressurized gas for a motor vehicle, comprising:
a support member consisting of a single cut and folded sheet metal element, comprising a receiving region delimited by the edges of a cut-out made in a central region of the sheet metal and configured to receive an end neck of the pressurized-gas tank, as well as a body which is provided with two opposite reinforcing walls obtained by folding the sheet metal and extending substantially in a plane normal to the axis along which the tank extends, and
a retaining collar attached to the support member, the receiving region and the retaining collar delimiting between them a passage opening configured to receive the end neck of the tank.

2. The attachment device according to claim 1, wherein the reinforcing walls are interconnected by a receiving wall of the retaining collar intended to receive attachment means for attaching the retaining collar to the body.

3. The attachment device according to claim 1, wherein the passage opening comprises an annular receiving element, in particular made from polymeric material, configured to receive the end neck of the tank.

4. The attachment device according to claim 1, wherein the retaining collar consists of a single cut and folded sheet metal element.

5. The attachment device according to claim 1, wherein the reinforcing walls are substantially parallel to one another.

6. The attachment device according to claim 1, wherein the body further comprises a first pair of reinforcing tabs obtained by folding the sheet metal and connecting the free ends of the reinforcing walls, so as to partially enclose a volume delimited by the two reinforcing walls.

7. The attachment device according to claim 1, wherein the body further comprises a second pair of reinforcing tabs obtained by folding the sheet metal and connecting respective opposite faces of the reinforcing walls, so as to partially enclose a volume delimited by the two reinforcing walls, the reinforcing tabs of the second pair of tabs being opposite those of the first pair of tabs in pairs.

8. The attachment device according to claim 6, wherein the reinforcing tabs are substantially parallel to one another.

9. The attachment device according to claim 6, wherein the reinforcing tabs extend substantially perpendicular to the reinforcing walls.

10. The attachment device according to claim 1, wherein the body further comprises at least one reinforcing tongue obtained by folding the sheet metal connecting two opposite segments of the edges of the cut-out made in the sheet metal, so as to partially close off a volume delimited by the two reinforcing walls and the receiving region.

11. The attachment device according to claim 1, wherein the body further comprises attachment bases provided with at least one attachment hole designed to receive means for attaching the attachment device to an attachment crossmember of the motor vehicle.

12. The attachment device according to claim 11, wherein the body further comprises a first pair of reinforcing tabs obtained by folding the sheet metal and connecting the free ends of the reinforcing walls, so as to partially enclose a volume delimited by the two reinforcing walls, and
wherein the attachment bases are obtained by folding an extension of the reinforcing tabs of the first pair of tabs, this folding preferably at 90°.

13. The attachment device according to claim 1, wherein the support walls are configured to receive an attachment crossmember of the motor vehicle between them.

14. The attachment device according to claim 1, wherein at least one of the two reinforcing walls is provided with at least one attachment hole designed to receive attachment means for attaching the attachment device to an attachment crossmember of the motor vehicle.

15. A tank for containing a pressurized gas for a motor vehicle, comprising an attachment device according to claim 1.
